(19) United States
(12) Patent Application Publication
(10) Pub. No.: US 2016/0057408 A1
(43) Pub. Date: Feb. 25, 2016

(54) Vibrating Grid Based 3D Space Visualization Device

(71) Applicant: József JÉGER, (US)

(72) Inventor: Józef JÉGER, Budapest (HU)

(21) Appl. No.: 14/779,764

(22) PCT Filed: Dec. 30, 2013
(86) PCT No.: PCT/HU2013/000137

§ 371 Date: Sep. 24, 2015

(30) Foreign Application Priority Data
Mar. 25, 2013 (HU) P1300171
Sep. 6, 2013 (HU) P1300519

(51) Int. Cl. H04N 13/04; G02B 27/22

(52) U.S. Cl. CPC H04N 13/0402; H04N 13/0413; G02B 27/225; H04N 2213/001

(57) ABSTRACT

The object of the present invention is a vibrating grid based space generating device, which enables 3D perception for the user, and which comprises a containing frame and image display surface, configured in such a manner that to the containing frame (1) is attached a vibrating grid (10) in a rotatable manner, which is equipped with vertically arranged matte black blocking strips (13) configured in a radial manner and focused into a vertical alignment, where the connecting elements (12) configured in the center line of the vibrating grid (10) join to the containing frame (1) so that when rotating the vibrating grid (10) in a horizontal direction on the containing frame (1), in the left and right side end positions of the distance of vibration (3), a 3D perception of earlier recorded images, alternating to the left (27) and right (28) eyes, displayed at an alternation rate of at least 24 images per second, displaced correspondingly to the interocular distance, is made possible on the image display surface (20) located behind the vibrating grid (10), while in the mid-position of the vibrating grid (10)—which is the moment of the alternation of the image—the uniform dark left and right side surface is formed by the blocking strips (13) for the left (27) and right (28) eyes simultaneously.

The present invention discloses a vibrating grid based space generating device for one or more persons which generates a realistic 3D-s view equivalent to natural sight without the need for specialized 3D glasses.

### FIELD OF THE INVENTION

The possible fields for application of the invention are those of health, education, communication, the entertainment (film, television) and advertising industries, various fields of science and research as well as those of national, public and private security.

### DESCRIPTION OF THE RELATED ART

The realization of 3D without glasses has already been achieved through various solutions (parallax barrier, lenticular, holographic and other methods), among which is the solution representing prior related art disclosed in patent document No. P1100360 HU and which presents a device for the display of stereoscopic pictures in which an unblocking pattern with a repetitive pattern for unblocking is placed between the image and the eyes in such a manner, that the unblocking pattern simultaneously allows the image intended for the left eye to be seen only by the left eye, the image intended for the right eye is left blocked to the left eye and the left eye does not see it, while allowing the image intended for the right eye to be seen only by the right eye, the image intended for the left eye is left blocked to the right eye.

The drawback to this solution is that both eyes see an image (i.e. two images) simultaneously, one image taken by a left side camera and one image take by a right side camera so that the images projected are unblocked to the opposite eye simultaneously and therefore approximately 50% of both images are visible to the corresponding eye. An additional drawback is that the unblocking blocks a certain portion of the two images which are simultaneously visible.

In the solution disclosed in the present invention there is no need for the abovementioned blocking, thus ensuring a superior quality of image, which can be seen by one eye at close to 100% of the image at a rate at least 1/24 images per second.

Patent document No. GB 2476160 also discloses a solution representing to prior related art and which discloses a flat panel 3D television which comprises a matrix of light sources rotating on a first axel, a collimation device which collimates the light emission from each source into one dimension, contains a device arranged to rotate the light sources, a modulation device which modulates the light intensity emitted from each light source, as well a rotation synchronizing device arranged to control and synchronize the rotation rate and/or angle of each light source. The object of the invention also includes a device which electronically stores a time-sequence of data of 2 dimensional mirror images of a 3D image emitted from a number of horizontally displaced viewpoints, where the mirror image data is used to drive the modulation device and/or rotation synchronization device in order to produce a real-time 3D mirror image of a given image.

The drawback to this solution representing prior related art is that due to the grid thickness placed horizontally and vertically between the rows of mirrors, the motor controlled mirrors projecting the images can project only a certain percent (50-60) of the image to the eyes. Therefore the images will always be grainy and incomplete. The apparatus is complicated, its manufacturing costly and real life 3D content is not achieved.

In examining the above solutions it may be clearly concluded that these technical solutions were unable to reproduce or create real-life three dimensional content.

A 3D image displayed should be in effect “presented” to the user, or users as if the user, or users were seeing it with their own eyes exactly as it appears in reality. Otherwise we provide our eyes and cerebellum, in an unnatural manner, with light and image effects produced improperly in various manners, which can produce dizziness or a general feeling of unwellness.

It is of course true that in the case of versions using glasses the viewer may choose from a variety of sizes of glasses but the probability that the viewer would choose those glasses which correspond to their own interocular distance is slight.

With both lenticular and parallax barrier applications in glasses-free 3D image displays presently on the market a certain degree of crosstalk is experienced, the result of which a realistic image is not produced and adverse health effects similar to the abovementioned may occur. These adverse health effects occur due to the fact among others that the cerebellum is unable to process the information intended for the other eye (the abovementioned crosstalk effect). This is clearly evident when the left and right images on a 3D display are simply switched. If also taken into consideration the improper display of the image inadequate to the interocular distance (the eyes angling outward or inward), the degree of adverse health effects to which users are often exposed is easily understandable.

One of the fundamental conditions of three dimensional sight is that the light source and image emitted from two different angles from the space before the viewer reach the two eyes almost at the same time, which the cerebellum perceives simultaneously, and then interprets as a three dimensional image.

The similarity as well as the difference in the two dimensional images appearing on the retina arise from the interocular distance, which differs from person to person but is approximately between 40 and 80 mm. The majority of people are convinced that they see in three dimensions, but this is not the case.

The image interpreted by the cerebellum is in fact composed of two individual two dimensional images. If one observes closely an object exactly opposite and in front, while alternately shutting one's left and right eyes, it may be concluded that in spite of the fact that the object remains in one place, the images seen are dislocated, i.e. move to the left and to the right as the left and right eyes see the left and right sides of the object. This dislocation corresponds precisely with the interocular distance of the viewer's eyes, the viewpoint of the left and right eye is defined by the distance of the object observed.

If one observes this same spectacle, i.e. the object located between the two eyes while at the same time concentrating on the background image, then it may be concluded that while one sees one image of the object, at the same time one sees a double image of parts of the image appearing in the background.

If this experiment is repeated inversely, i.e. if one observes one of the objects appearing in the background while concentrating on a closer object in the foreground, then one comes to the same conclusion.

Consequently the experiment outlined and presented above clearly proves that in reality one does not see in three dimensions, because if one were to see in three dimensions then during the second experiment in both cases one would see only one of everything in the background, and not two.

In creating the present invention the inventor's goal was to create a glasses-free 3D image display so that, taking into consideration previous conclusions, the inventor approached the question of the solution of 3D vision from the aspect of his aforementioned conclusions.

It is well known that the cerebellum, in some way, even if disconcerting to it, comprehends and interprets the image appearing on the retina independently of how it came to be there. With this knowledge it is also clear that the brain is capable of interpreting a reproduced 3D recording or image if the two images creating the 3D recording or image reach the eyes from a two dimensional (flat) surface so that one eye does not see what is visible to the other eye at a given time.

When looking through a rotating blade fan from up close, the space beyond the blades of the fan is seen in depth, i.e. in 3D, independently of the fact that the viewer is seeing through the blades with only one eye at one time. One of the fundamental conditions for 3 dimensional sight is that the two eyes see at least two two-dimensional images at approximately the same time.

If, following this observation, the viewer moves slowly backward from the fan the depth, i.e. the 3D spectacle will be seen in the same manner by the two eyes and the cerebellum.

In the process of creating the present invention the recognition was that, in order to produce a 3D spectacle, or spatial image similar to natural sight, the inventor was able to provide the solution to the given objective with the aid of a special grid device created by him, namely each eye separately viewing images displayed or reproduced at approximately the same time in such a manner that the image display surface at the moment of the alternation of the image at a time not sensed by the cerebellum at a rate of approximately 1/100^{th} of a second—is separated by a uniform dark surface from the two eyes in the exact same way as in the creation and replay of moving pictures. The spectacle termed 3D is in fact the uniform interpretation, i.e. fusion of a two dimensional image which appears twice in the cerebellum. A further recognition was that the spectacle of a glasses-free 3D real-life moving image, contrary to the solutions available thus far, can also be produced if the corresponding images reach the appropriate eyes from a two dimensional flat surface at an alternation rate of at least 1/24 images per second so that in the meantime there is a specially configured grid type device in front of the alternating left and right images projected on the surface being moved by vibration to the left and to the right, and the movement of which is on the one hand synchronized to the rate of the alternation of the images, and on the other hand ensures the seeing through the grid device by alternating eyes in such a manner that while the one eye sees through the grid, the other eye is prevented simultaneously by the grid from doing the same. If the images are displayed on the image display surface so that their “displacement” from each other in a horizontal direction (which is particular to each individual) corresponds precisely to the interocular distance of the user, if the user is placed at a certain distance and at a certain focused alignment of vertical height from the construction thus arranged and configured, furthermore if the images displayed at a rate of at least 1/24 images per second are composed from the left-right images from an image taken with a 3D camera, and a certain dead zone (at the moment of image alternation) is applied between the appearance of those images, then the objective of the present invention has been realised.

### SUMMARY OF THE INVENTION

The object of the present invention therefore is a vibrating grid based space visualization device, which makes possible 3D perception for the user, which comprises a containing frame and image protection surface configured is such a manner that a vibrating grid with matte black blocking strips focused into a vertical alignment arranged in a radial manner is configured in the containing frame, where the connecting elements, preferably pivots, configured in the center line of the vibrating grid join the vibrating grid to the containing frame, allowing the rotation in a horizontal direction on the pivots of the vibrating grid so that in the right and left end positions of the grid the 3D perception of earlier recorded images appearing at an alternation rate of at least 24 images per second becomes visible in alternation to the left and right eyes on the image projecting surface located behind the vibrating grid, while at the same time in the mid-position of the vibrating grid, which is the moment of the alternation of the images, for the right and left eye simultaneously, the uniform dark left-right side surface formed by the blocking strips becomes visible, i.e. neither eye sees through the grid.

The characteristic configurations of the vibrating grid based space visualization device according to the invention are presented in detail in the claims.

The solution according to this invention is described in greater detail via the following drawings:

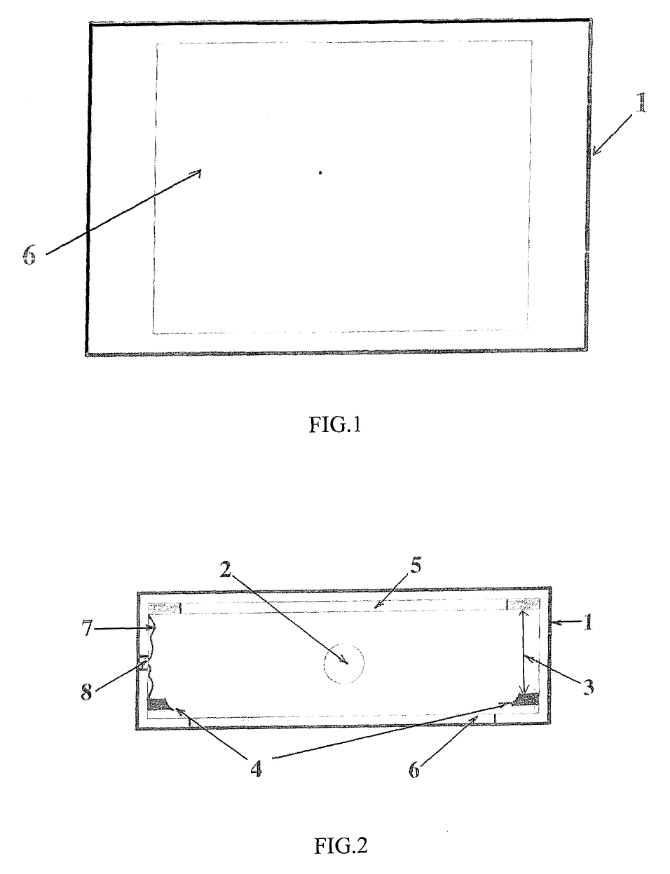

FIG. 1 shows a front view of the containing frame,

FIG. 2. shows a top view of the containing frame,

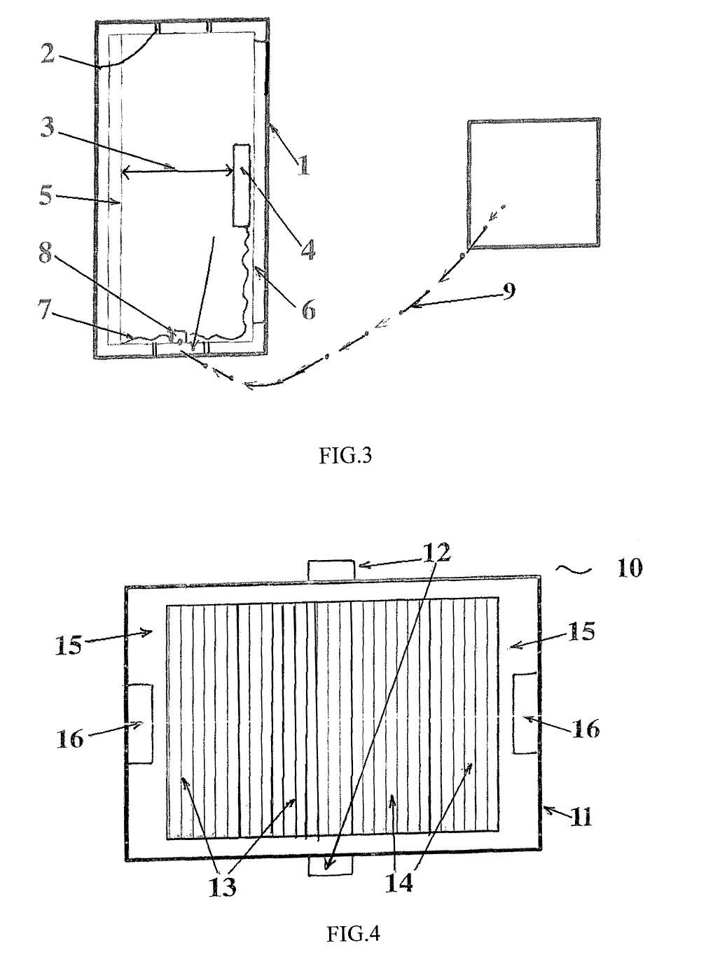

FIG. 3. shows a side view of the containing frame, with the controlling cable and potentiometer,

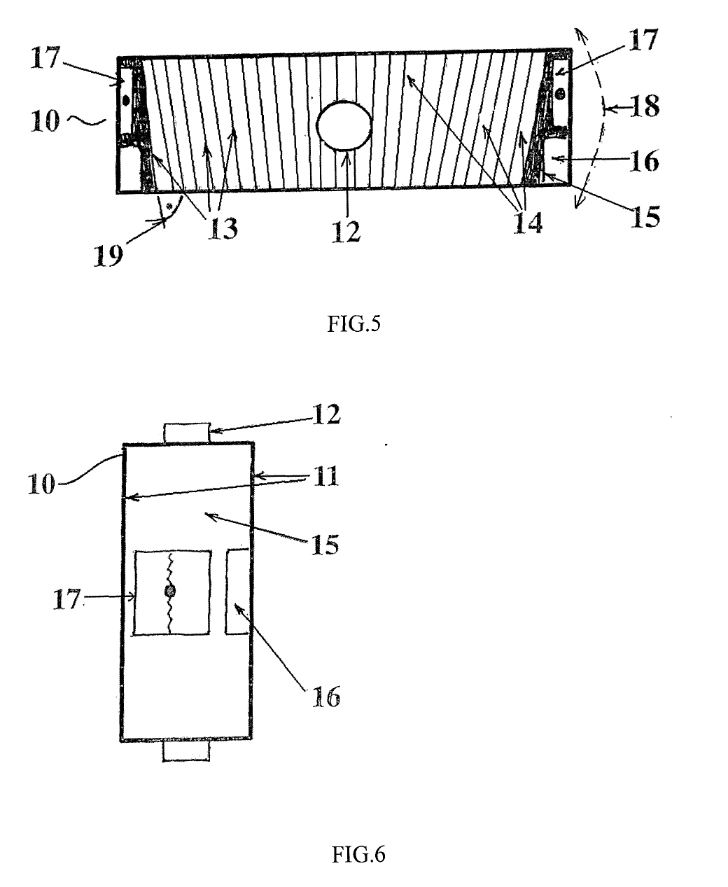

FIG. 4 shows a front view of the vibrating grid,

FIG. 5 shows a top view of the vibrating grid,

FIG. 6 shows a side view of the vibrating grid,

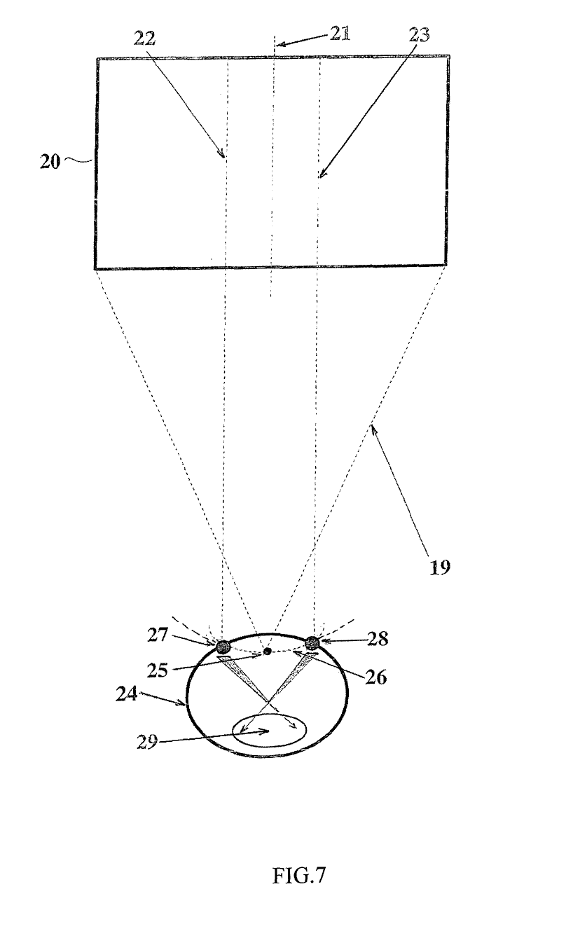

FIG. 7 shows a perspective view showing the position of the image display surface, the eye as well as the cerebellum,

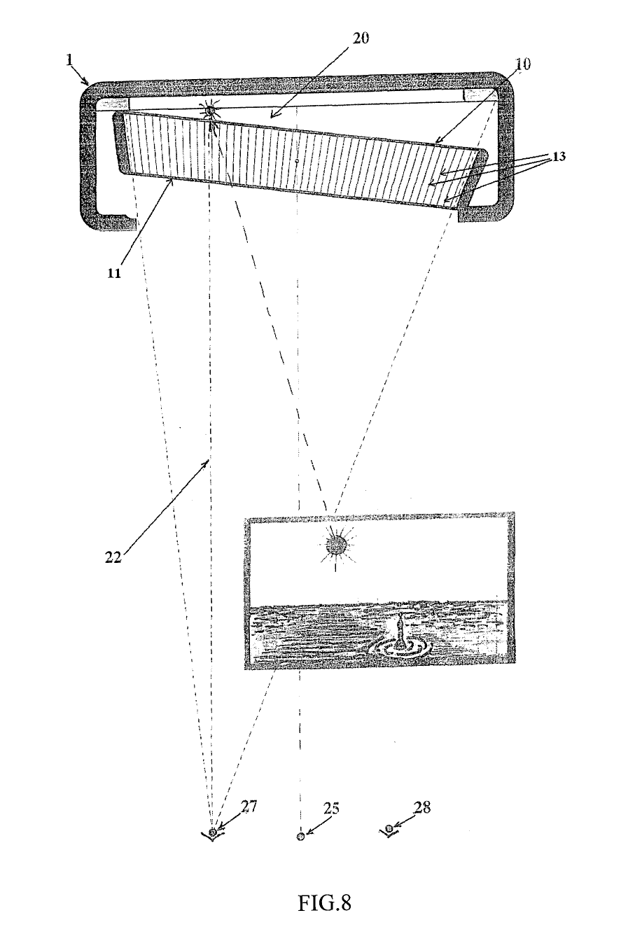

FIG. 8 presents the operation of the device according to the invention from a top view in the position at the moment in which the left eye is seeing through the grid,

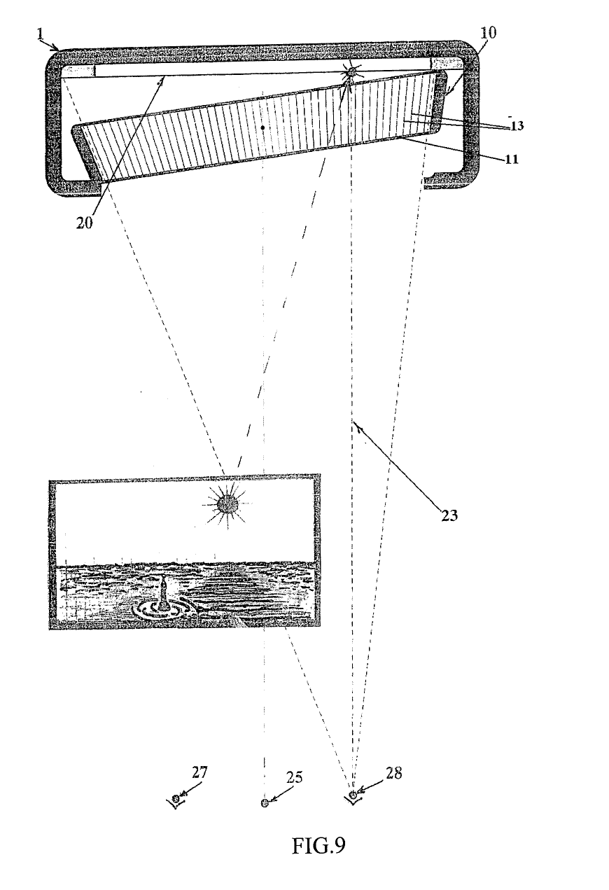

FIG. 9 presents the operation of the device according to the invention from a top view in the position at the moment in which the right eye is seeing through the grid,

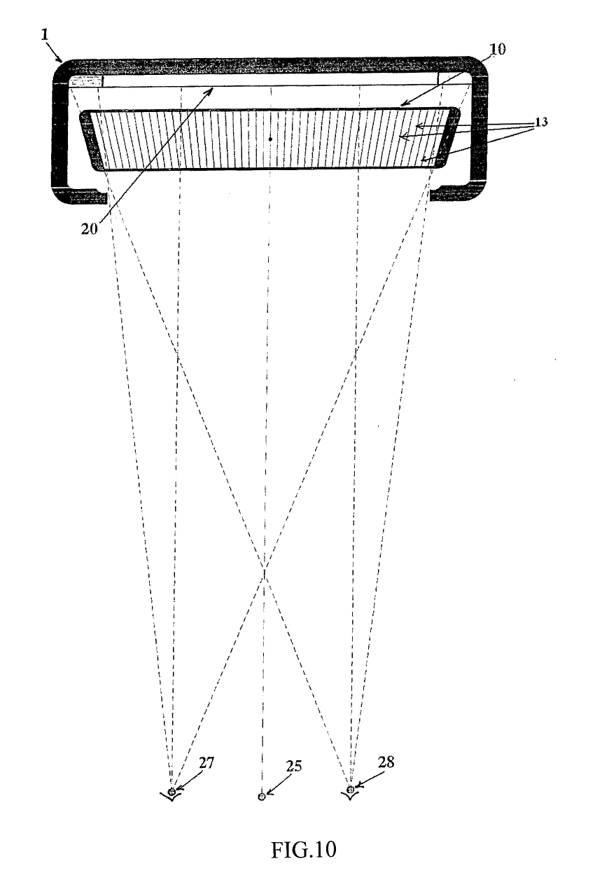

FIG. 10 presents the operation of the device from a top view in such a “particular” position at the moment in which the alternation of the image occurs.

FIG. 1 shows the containing frame 1 and the transparent cover panel 6 according to the invention.

Referring to FIGS. 2 and 3 clearly visible in the top view and the side view of the containing frame 1 is the connecting port 2, the vibrating distance 3, on both sides the magnetic stop-pins 4, the image projection housing 5, the transparent front panel 6, the wire 7, the control unit 8, as well as the control cable 9, which is connected preferably to a potentiometer.

Referring to FIGS. 4, 5, and 6 visible in the front, top and side view of the vibrating grid according to the invention is the frame 11, the connecting elements 12, preferably pivots, the blocking strips 13, the slits configured between them 14, the buffer columns 15, the iron insert 16, the vibration absorbers 17, as well as the curve of vibration 18 which develops in the course of the vibration. In the top view in FIG. 5 is clearly visible the viewpoint 19 ensuring optimal viewing.

FIG. 7 presents the operation of the device according to the invention, in which the explanatory markings corresponding to the user and to the image display surface 20 are visible, such as center line of space 21, the left center line of the image 22, the right center line of the image 23, the focal point of the viewpoint 25, the curve of the focal point 26, the left eye 27, the right eye 28 and the cerebellum 29 of the user.

FIG. 8 illustrates the operation of the device according to the invention in a perspective view in the position at the moment in which the left eye 27 sees through the grid. Visible is the containing frame 1, the image display surface 20 configured on the interior surface of the containing frame 1, as well as the vibrating grid 10 configured in the interior of the containing frame 1 and rotated towards the left, and within the frame of which 11, blocking strips 13 are configured in a radial direction. In this position it is evident that the left eye 27 sees the image.

FIG. 9 illustrates the operation of the device according to the invention in a perspective view in the position at the moment in which the right eye 28 sees through the grid. Visible is the containing frame 1, with the image display surface 20, as well as the vibrating grid 10, within the frame of which 11 are configured the blocking strips 13. The vibrating grid 10 is rotated towards the right, thus the right eye 28 sees the image.

FIG. 10 illustrates the operation of the device according to the invention in a perspective view in such a “particular” position at the moment in which the alternation of the image occurs. At the moment of the alternation of the image the blocking strips 13 of the vibrating grid 10 prevent both eyes simultaneously from seeing through the grid. The left eye 27 sees the left side uniform dark surface formed by the left side of the blocking strips 13, while the right eye 28 sees the right side dark surface, i.e. both eyes are prevented simultaneously from seeing through the grid.

### DETAILED DESCRIPTION OF PREFERRED OPERATION OF THE EMBODIMENT.

The containing frame 1 according to the invention in a possible construction is configured so that it incorporates the image display surface 20 and the vibrating grid 10 located in front it, and joins both together with the purpose of reproducing a three dimensional image in such a manner that when the left 27 and right 28 eyes see through the vibrating grid 10 in operation, the continuous alternation of the left and right images appearing in alternation on the image display surface 20 enables a real-life 3D perception through the left 27 and right 28 eyes reaching the cerebellum 29.

The connecting ports 2 for the containing frame 1 securing the connecting elements 12, preferably pivots of the vibrating grid 10 ensure the possibility for the stabile rotation of the vibrating grid 10 towards the left and towards the right, the operation of which is ensured by the control unit 8.

The latitude of the vibrating grid 10 is defined by the curve of vibration 3, and ensured in the end position of the adjustable stop-pins 4.

In one configuration the image display surface 20 is located in the image projection housing 5, parallel to the back wall of the containing frame 1, the transparent front panel 6 is imbedded in the front wall.

The operation and modulation of the units of the vibrating grid 10 and the image display surface 20 operating in synchronization with the containing frame 1 is ensured by the control unit 8 through the controlling cables 9.

The user by manually adjusting the resolution of the image “inputs his own interocular distance into the device” which is accomplished by bringing the left and right center lines of the image 22, 23 and the curve of vibration 18 into synchronization. Due to differing interocular distances the device according to the invention is able to serve the needs of only one, maximum two users provided that the interocular distances are more or less the same and their heads are located over or possibly behind one another (the user in front is always the person with the smaller interocular distance). This mode of operation is useful in various educational fields. The images corresponding to the left and right center lines of the image 22, 23 projected on the front wall of the image display surface 20 will appear in every case displaced towards the right and towards the left from the center line of the image display surface at a distance corresponding to the interocular distance of a given user so that the left and right center lines of the image 22,23 are always parallel to the eyes. The viewer will see the image, images displayed as if his interocular distance were the same as that of the interaxial distance between the cameras was at the time of capturing the images, i.e. he will see a flower exactly as it is seen by a bee.

The left and right images taken by a 3D camera appear alternating at a rate of at least (12+12), i.e. 24 times within one second on the image display surface 20 so that at the moment of their appearance, the vibrating grid 10 located in front of the images ensures the possibility of seeing through the grid in one of its end positions for the corresponding left 27 and right 28 eyes.

The 3D cameras must be always placed parallel to each other during image shooting. Their distance from each other, however, may be arbitrary. For instance in their application in the field of space research that distance could be several thousand kilometers, while the distance could be less than a millimeter in the case of microscopic image taking.

The vibrating grid 10 is a unit specially configured in a vertical manner, but with the containing frame able to be tilted at approximately a 90 degree angle and can be rotated horizontally in both directions on the pivots 12, in which the frame 11 part of which are such vertically arranged blocking strips 13 configured in a radial manner, and which provides three modes of viewing through the grid. The configuration of the blocking strips 13 may be realised mechanically, electronically and with liquid crystals as well. Amongst the three possibilities for viewing through the grid two provide viewing through the grid for the left 27 and right 28 eyes, while the third possibility prevents both eyes simultaneously from viewing through the grid at the moment of image alternation.

With the display generated in accordance to the invention the cerebellum 29 (mistakenly) is in the “knowledge” that the two eyes before it perceive, i.e. see the image simultaneously interpreted by it (implicitly) to be in 3D.

The configuration of the vibrating grid 10 may be accomplished by several technical means e.g.: mechanically, electronically or with liquid crystals, the latter being advantageous for smaller image display surfaces (mobile telephones, tablets, laptops).

A number of these specially configured vibrating grids 10 may be placed, built beside one another.

The distance of the image display surface behind the vibrating grid 10 (in a room constructed for a number of people) may be arbitrary thus, when using a number of vibrating grids 10, a 3D display can be resolved on a single image display surface (e.g. a film screen), which is the objective related to the present invention.

The solution according to this invention therefore meets its set objectives and offers the following advantages:
at least 90% of the image displayed on the image display surface is visible,
there is no crosstalk in the images seen by the individual eyes, therefore there is no distortion,
the distance between the images seen by the left and right eyes corresponds to the interocular distance of the user, therefore there are no adverse health effects, no eye fatigue,
the invention can be used for any variant of height and viewpoint of the user in the vertical plane of the center line of space,
the vibrating grid with the frame can be tilted from the vertical plane at a 45-45 degree, i.e. a 90 degree angle, the user therefore can see the image not only with perpendicular vision,
the design of the invention lends itself to low cost manufacture and quick, easy assembly,
the configuration of the blocking strips can be realized mechanically, electronically and with liquid crystals,
the invention lends itself to a variety of applications: e.g. its efficient use is possible in the field of health with cameras adjusted for small distances, while with larger distances it is applicable in the field of space research. A normal camera distance (that corresponding to an average interocular distance) can be effective in use in education, entertainment and other fields.

### LIST OF REFERENCE SIGNS

1. containing frame

2. connecting port

3. distance of vibration

4. magnetic stop-pins

5. image projection housing

6. transparent front panel

7. wire

8. control unit

9. controlling cable

10. vibrating grid

11. frame

12. connecting elements, pivots

13. blocking strips

14. slits between the strips

15. buffer columns

16. iron insert

17. vibration absorber

18. curve of vibration

19. viewpoint

20. image display surface

21. center line of space

22. left center line of the image

23. right center line of the image

24. user

25. focal point of the viewpoint

26. curve of focal point

27. left eye

28. right eye

29. cerebellum

1. A vibrating grid based space generating device which enables 3D perception for a user, comprising
a containing frame and image display surface, said containing frame being attached to a vibrating grid in a rotatable manner, one or more vertically arranged matte black blocking strips configured in a radial manner and focused into a vertical alignment,
wherein one or more connecting elements configured in the center line of the vibrating grid join the vibrating grid to the containing frame for the purpose of its rotation in a horizontal direction, in the left and right side end positions of the distance of vibration of the vibrating grid making possible the 3D perception of earlier recorded images,
alternating to the left and right eyes of the user, displaced correspondingly to the interocular distance of the user, displayed at an alternation rate of at least 24 images per second on the image display surface located behind the vibrating grid, while in the mid-position of the vibrating grid which is the moment of the alternation of the image a uniform dark left and right side surface is formed by the blocking strips for the left and right eyes of the user simultaneously.

2. The vibrating grid based space generating device of claim 1 wherein said image display surface is configured behind the vibrating grid on the interior surface of the containing frame.

3. The vibrating grid based space generating device of claim 1, wherein said image display surface is located at an arbitrary distance from the vibrating grid.

4. The vibrating grid based space generating device of claim 1, wherein said configuration of the blocking strips is achieved mechanically or electronically.

5. The vibrating grid based space generating device of claim 1, wherein said configuration of the blocking strips is achieved with liquid crystals.

6. The vibrating grid based space generating device of claim 5, wherein said operation of the vibrating grid occurs with alternating current.

7. The vibrating grid based space generating device of claim 1, wherein said vibrating grids may be built side by side.

8. The vibrating grid based space generating device of claim 1, wherein said optimal movement of the vibrating grid is ensured by a control unit.
